(19) United States
(12) Patent Application Publication
(10) Pub. No.: US 2014/0084845 A1
(43) Pub. Date: Mar. 27, 2014

(54) Charger and Charge Control Circuit for Use Therein

(71) Applicant: Nien-Hui Kung, Hsinchu City (TW)

(72) Inventor: Nien-Hui Kung, Hsinchu City (TW)

(73) Assignee: Richtek Technology Corporation

(21) Appl. No.: 13/624,691

(22) Filed: Sep. 21, 2012

(51) Int. Cl. H02J 7/00

(52) U.S. Cl. 320/107

(57) ABSTRACT

The present invention provides a charger circuit for supplying power from an external power source to a first common node and charging a second common node from the first common node; a regulator circuit is coupled between the external power source and the first common node. The charger circuit includes a switching regulator power stage for controlling charging to the second common node. The switching regulator power stage supplies power to the second common node according to detected voltage at the first common node, detected voltage at the second common node, and charging current to the second common node.

### BACKGROUND OF THE INVENTION

1. Field of Invention

The present invention relates to a charger and a charge control circuit for use therein, especially a charger and a charge control circuit for charging a second common node from a first common node by a switching regulator.

2. Description of Related Art

A typical charger circuit needs to be capable of supplying power to a system from an external power source while charging a battery at the same time. When the external power source supplies power to the system and charges battery concurrently, the battery should not discharge through a path to the system; otherwise, the battery can never be fully charged. To this end, it is typical to maintain a voltage difference between the battery and the system, i.e., to keep the system voltage higher than the battery charging voltage by a predetermined voltage difference, so that the battery does not discharge to the system.

FIG. 1 shows a relation between the battery charging voltage Vbat and the system voltage Vsys when their power are provided from an external power source. A voltage difference Vos is set between the battery charging voltage Vbat and the system voltage Vsys, which is a predetermined constant determined by a designer in a conservative manner, to maintain the battery charging voltage Vbat lower than the system voltage Vsys. However, because the voltage difference Vos is predetermined in a conservative manner, it is usually not optimum and can cause unnecessary power waste.

FIG. 2 shows a simplified schematic diagram according to U.S. Pat. No. 7,710,079, wherein a charger circuit 10 includes a regulator 11, a charge control unit 12, an internal voltage source 14, a transistor Q1, an error amplifier 13, a system terminal (system voltage) Vsys, and a battery terminal (battery charging voltage) Vbat. The regulator 11 is coupled to an external power source Vbus and generates power which is supplied to the common node N11. The transistor Q1 is coupled between the common node N11 and common node N12, and it has a drain current Id. The charge control unit 12 is coupled to the gate G1 of the transistor Q1. The internal voltage source 14 is coupled between the common node N12 and the error amplifier 13, and it generates a voltage Vos. The error amplifier 13 includes an inverting input and two non-inverting inputs, wherein the inverting input is coupled to the common node N11 and the two non-inverting inputs are respectively coupled to the output of the internal voltage source 14 and a reference voltage Vref. This reference voltage Vref for example corresponds to the supply voltage 3.4V as shown in FIG. 1. When the charger circuit 10 is in the charge stage I as shown in FIG. 1, the error amplifier 13 compares the system voltage Vsys with the reference voltage Vref, to generate a control signal so that the output voltage of the regulator 11 maintains a corresponding relation with the reference voltage Vref. When the charger circuit 10 is in the charge stage II in FIG. 1, the error amplifier 13 compares the system voltage Vsys and the voltage at the output end of the internal voltage source 14 (the output voltage of the internal voltage source 14 is Vbat+Vos), to generate a control signal for maintaining the voltage difference Vos between the output voltage of the regulator 11 and the battery charging voltage Vbat. However, as explained in the above, the voltage difference Vos causes power waste (Vos×Id).

Therefore, it is important to improve the battery charging efficiency and reduce power waste in this field.

### SUMMARY OF THE INVENTION

The present invention provides to a charger and a charge control circuit for use therein, especially a charger and a charge control circuit for charging a second common node from a first common node by a switching regulator, which can effectively improve charging efficiency and reduce unnecessary power waste.

The above and other objects and benefits of the present invention can be further understood from the disclosed technical features.

The present invention provides a charger for supplying power from an external power source to a first common node and charging a second common node from the first common node. The charger includes: a regulator, coupled between the external power source and the first common node, for charging the first common node from the external power source; a switching regulator power stage, coupled between the first common node and the second common node for charging the second common node from the first common node, the switching regulator power stage being controlled according to a first control signal, a second control signal, and a third signal; a first amplifier, for generating the first control signal supplied to the switching regulator power stage according to a voltage at the second common node and a first reference signal; a second amplifier, for generating the second control signal supplied to the switching regulator power stage according to a charging current to the second common node and a second reference signal; and a third amplifier, for generating the third control signal supplied to the switching regulator power stage according to a voltage at the first common node and a third reference signal.

From another point of view, the present invention also provides a charge control circuit for supplying power from an external power source to a first common node and charging a second common node from the first common node, wherein a regulator is coupled between the external power source and the first common node, and a switching regulator power stage is coupled between the first common node and the second common node. The charge control circuit includes: a first amplifier, for generating a first control signal supplied to the switching regulator power stage according to a voltage at the second common node and a first reference signal; a second amplifier, for generating a second control signal supplied to the switching regulator power stage according to a charging current to the second common node and a second reference signal; and a third amplifier, for generating a third control signal supplied to the switching regulator power stage according to a voltage at the first common node and a third reference signal; wherein the switching regulator power stage controls the charging from the first common node to the second common node according to the first control signal, the second control signal, and the third signal.

In a preferable embodiment of the present invention, the charger and charge control circuit further include a fast charge control switch, which is coupled between the first common node and the second common node for fast charging the second common node from the first common node. In one embodiment, the fast charge control switch is a transistor which is conducted when the voltage at the second common node is lower than a threshold.

In a preferable embodiment of the present invention, the charger and charge control circuit further include a discharge control unit, which is coupled between the second common node and the first common node for controlling discharge from the second common node to the first common node according to the voltages of the first common node and the second common node.

In a preferable embodiment of the present invention, the charger and charge control circuit further include a first voltage sensing unit, which is coupled between the first amplifier and the second common node, wherein the first amplifier receives information of the voltage at the second common node through the first voltage sensing unit.

In a preferable embodiment of the present invention, the charger and charge control circuit further include a current sensing unit for sensing the charging current, wherein the second amplifier receives information of the charging current through the current sensing unit.

In a preferable embodiment of the present invention, the charger and charge control circuit further include a second voltage sensing unit, which is coupled between the third amplifier and the first common node, wherein the third amplifier receives information of the voltage at the first common node through the second voltage sensing unit.

In a preferable embodiment of the present invention, the charger and charge control circuit further include a fourth voltage sensing unit, which can generate a fourth control signal according to the voltage at the first common node and a fourth reference signal, to control the regulator for charging the first common node.

The objectives, technical details, features, and effects of the present invention will be better understood with regard to the detailed description of the embodiments below, with reference to the drawings.

### BRIEF DESCRIPTION OF THE DRAWINGS

FIG. 1 shows the relation between the battery charging voltage Vbat and the system voltage Vsys in prior art.

FIG. 2 shows a simplified schematic diagram of a prior art charger circuit.

FIGS. 3A and 3B show two preferable embodiments of the charger and charge control circuit according to the present invention.

FIG. 4 shows a preferable embodiment of a fast charge control switch according to the present invention.

FIG. 5 shows a preferable embodiment of a discharge control unit according to the present invention.

FIG. 6 shows a preferable embodiment of a switching regulator power stage according to the present invention.

FIG. 7 shows a relation between battery charging voltage Vbat and system voltage Vsys according to the present invention.

### DESCRIPTION OF THE PREFERRED EMBODIMENTS

The drawings as referred to throughout the description of the present invention are for illustrative purpose only, but not drawn according to actual scale. The orientation wordings in the description such as: top, bottom, left, or right are for reference with respect to the drawings only, which do not restrict the origination of an actual product made according to the present invention.

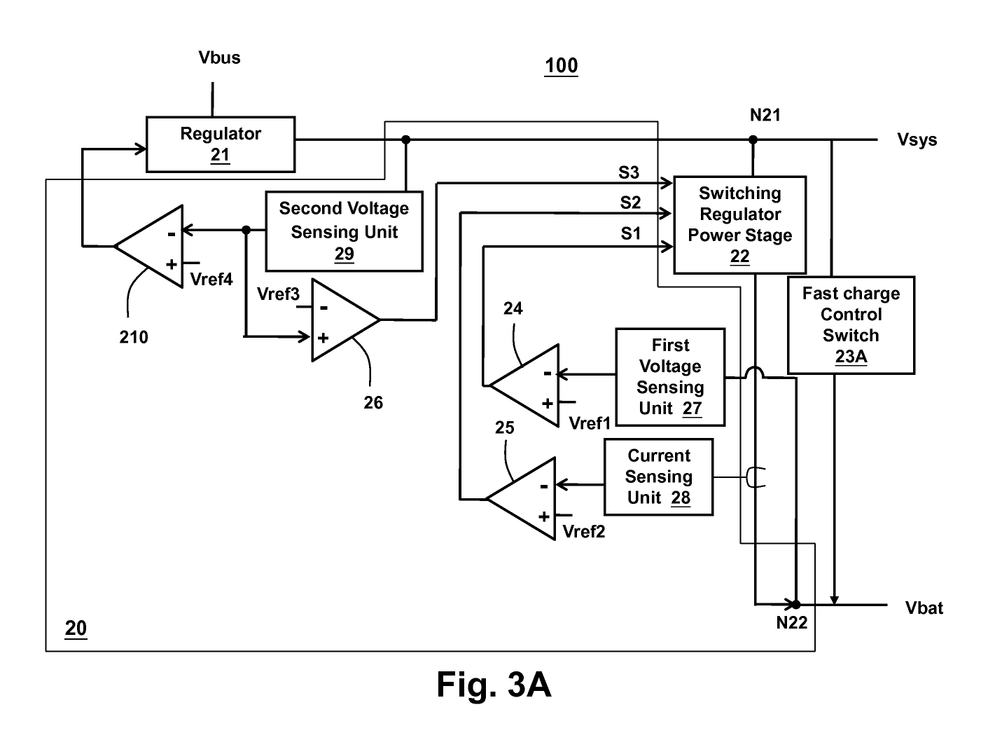

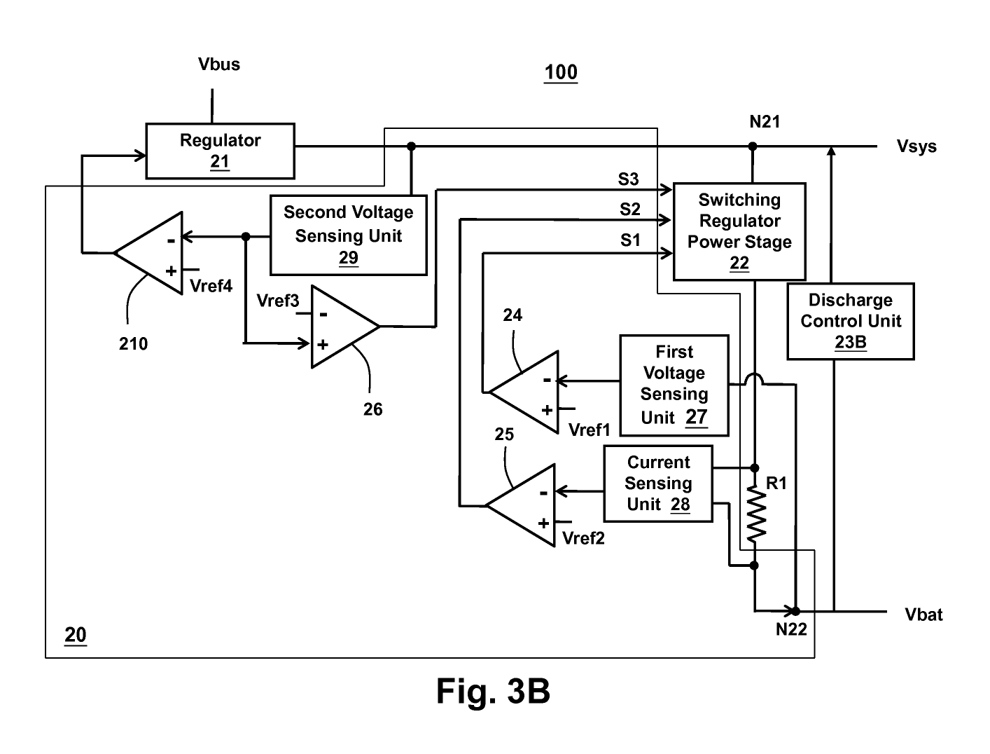

Please refer to FIG. 3A, wherein an embodiment of a charger 100 and a charge control circuit 20 for use therein according to the present invention is shown. The charger 100 supplies power from an external power source Vbus to a first common node N21 and charges a second common node N22 from the first common node N21. The charger 100 includes a regulator 21 coupled between the external power source Vbus and the first common node N21; a switching regulator power stage 22 coupled between the first common node N21 and the second common node N22; and a charge control circuit 20 for controlling the regulator 21 and the switching regulator power stage 22. The charge control circuit 20 includes a first amplifier 24, a second amplifier 25, a third amplifier 26, and a fourth amplifier 210. Optionally, the charge control circuit 20 can include one or more voltage sensing units (such as the first voltage sensing unit 27 and the second voltage sensing unit 29), and a current sensing unit (such as the current sensing unit 28). The charge control circuit 20 can be integrated into an integrated circuit, or integrated with part or all of the devices of the regulator 21 and the switching regulator power stage 22 to become an integrated circuit.

The switching regulator power stage 22 charges the second common node N22 from the first common node N21; it is controlled according to a first control signal S1, a second control signal S2, and a third signal S3. The first control signal S1 is responsive to the status of the voltage at the second common node N22, which can be generated by the first amplifier 24 according to the voltage at the second common node N22 and a reference signal Vref1. In one embodiment, the first amplifier 24 can compare the voltage at the second common node N22 with the first reference signal Vref1 directly. In the embodiment as shown in figure, the first amplifier 24 receives information of the voltage at the second common node N22 through the first voltage sensing unit 27, that is, the first voltage sensing unit 27 senses the voltage Vbat at the second common node N22 and the first amplifier 24 compares the voltage Vbat sensed by the first voltage sensing unit 27 with the first reference signal Vref1. The first voltage sensing unit 27 can be a voltage divider circuit for example. The second control signal S2 is responsive to the status of the charging current to the second common node N22, which can be generated by the second amplifier 25 according to the charging current supplied through the switching regulator power stage 22 to the second common node N22 and a second reference signal Vref2, wherein information of the charging current can be obtained for example by a current sensing unit 28. The current sensing unit 28 can be implemented in various forms; as a non-limiting example, a resistor can be connected in the current path and the voltage difference between both ends of the resistor indicates information of the charging current. The third control signal S3 is responsive to the status of the voltage at the first common node N21, which can be generated by the third amplifier 26 according to the voltage at the first common node N21 and a third reference signal Vref3. In one embodiment, the third amplifier 26 can compare the voltage at the first common node N21 with the third reference signal Vref3 directly. In the embodiment as shown in figure, the third amplifier 26 receives information of the voltage Vsys at the first common node N21 through the second voltage sensing unit 29, that is, the second voltage sensing unit 29 senses the voltage Vsys at the first common node N21, and the third amplifier 26 compares the voltage Vsys sensed by the second voltage sensing unit 29 with the third reference signal Vref3. The second voltage sensing unit 29 can be a voltage divider circuit for example.

The aforementioned first reference signal Vref1, second reference signal Vref2, and third reference signal Vref3 can be designed according to practical requirements, to respectively set the upper limit of voltage Vbat, the upper limit of the charging current, and the relation between voltage Vsys and voltage Vbat. The first reference signal Vref1, second reference signal Vref2, and third reference signal Vref3 can respectively be constant values or variables.

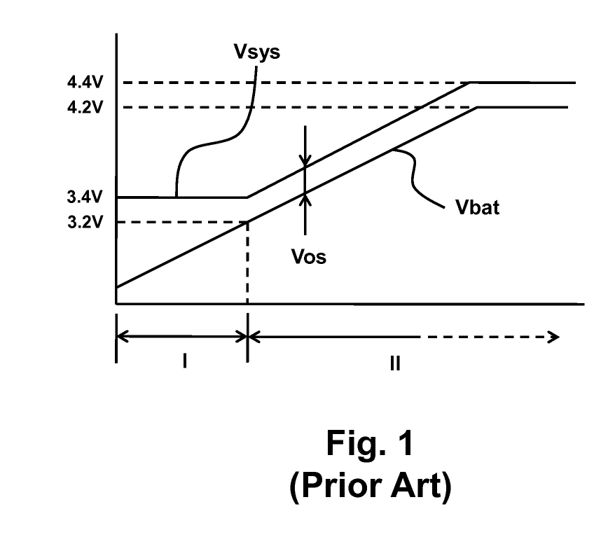

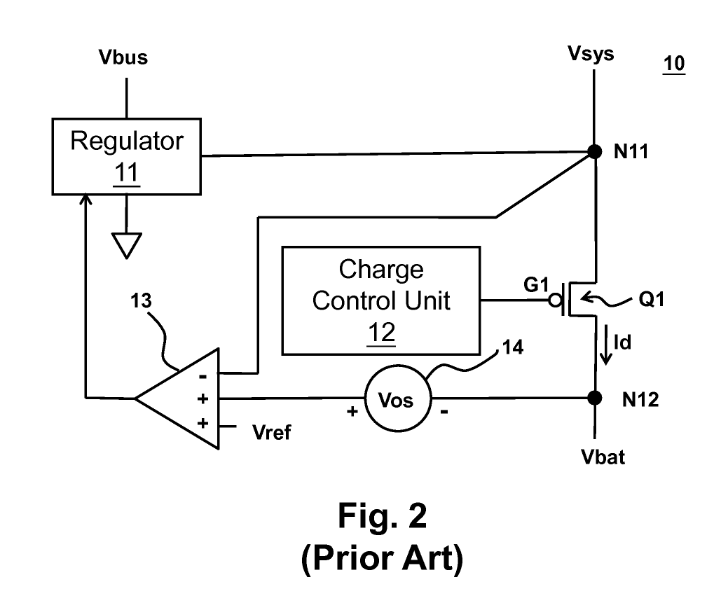

Still referring to FIG. 3A, the charge control circuit 20 can further include a fourth amplifier 210 for controlling the regulator 21 to supply the voltage Vsys to the first common node N21. The fourth amplifier 210 generates a fourth control signal (not labeled in the figure) according to the voltage Vsys at the first common node N21 and a fourth reference signal Vref4; the fourth control signal controls the operation of the regulator 21 to supply power to the first common node N21. In one embodiment, the fourth amplifier 210 can directly compare the voltage Vsys at the first common node N21 with the fourth reference signal Vref4. In the embodiment as shown in figure, the fourth amplifier 210 receives information of the voltage Vsys at the first common node N21 through the second voltage sensing unit 29, that is, the second voltage sensing unit 29 senses the voltage Vsys at the first common node N21, and the fourth amplifier 210 compares the voltage Vsys sensed by the second voltage sensing unit 29 with the fourth reference signal Vref4, to generate the fourth control signal. How the regulator 21 controls the voltage Vsys depends on the setting of the fourth reference signal Vref4, and it can be set according to practical requirements. For example, the regulator 21 and the switching regulator power stage 22 can respectively be controlled so that the voltage Vsys and the voltage Vbat follow the relation as shown in FIG. 1; however, the relation between the voltage Vsys and the voltage Vbat is not limited to the example of FIG. 1, and as an example, they can be controlled to follow the relation as shown in FIG. 7.

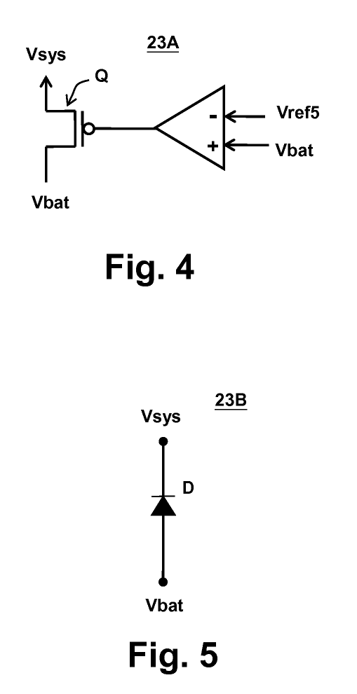

Still referring to FIG. 3A, the charge control circuit 20 can further include a fast charge control switch 23A. Referring to FIG. 4, the fast charge control switch 23A can include a transistor Q and an error amplifier (or a comparator), wherein the error amplifier or the comparator compares the voltage Vbat with a fifth reference signal Vref5. When the comparing result shows that the voltage Vbat is too low, that is, lower than a threshold defined by the fifth reference signal Vref5, the transistor Q can be conducted to accelerate the charging operation from the first common node N21 to the second common node N22. The transistor Q can be but not limited to a field effect transistor (such as the PMOS field effect transistor shown in the figure or an NMOS field effect transistor; the inverting and non-inverting inputs of the amplifier/comparator should be correspondingly arranged). Besides the above example wherein the fast charge control switch 23A is controlled according to the comparison between the voltage Vbat and a fifth reference signal Vref5, which is only illustrative but not limiting, the fast charge control switch 23A can be controlled by various other methods (such as by comparing the voltage Vsys with voltage Vbat, or by comparing the fifth reference signal Vref5 with a voltage difference between the voltage Vsys and the voltage Vbat). That is, the purpose to provide the fast charge control switch 23A is to fast charge the voltage Vbat when the voltage Vbat is too low. Therefore, any method which can determine that the voltage Vbat is too low and provide an indication signal can be used to conduct the fast charge control switch 23A.

Referring to FIG. 3B, the charge control circuit 20 can further include a discharge control unit 23B. FIG. 5 shows an preferable embodiment of the discharge control unit 23B according to the present invention, wherein the discharge control unit 23B includes a diode D and its anode and cathode are respectively coupled to the battery charging voltage Vbat and system voltage Vsys. The diode D charges the first common node N21 from the second common node N22 according to the relation between the voltage Vbat and the voltage Vsys.

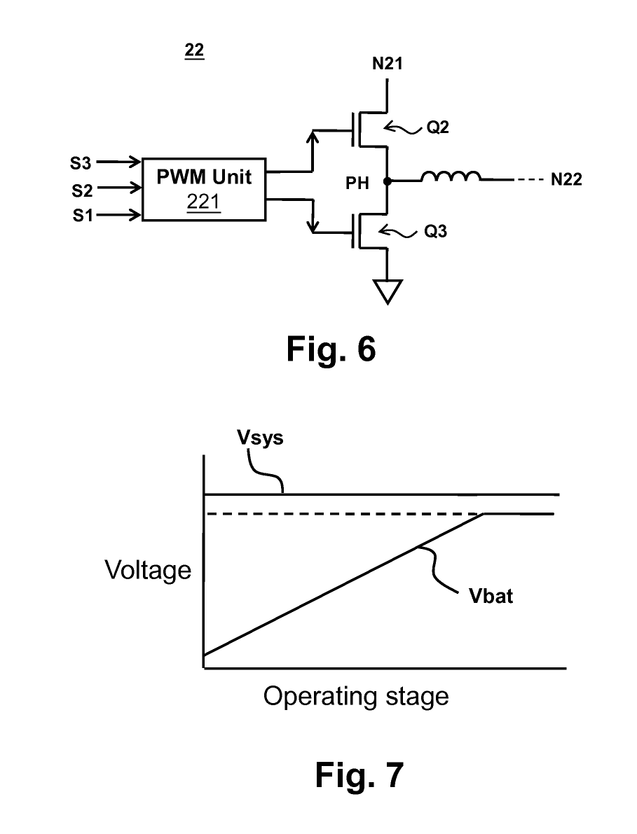

FIG. 6 shows an example of the switching regulator power stage 22. The switching regulator power stage 22 can include a pulse width modulation unit (PWM unit) 221, an upper transistor switch Q2, a lower transistor switch Q3, and an inductor, wherein the upper switch transistor Q2, the lower switch transistor Q3, and the inductor are commonly coupled to a third common node PH. The PWM unit 211 controls the operation of the upper transistor switch Q2 and the lower transistor switch Q3 according to the first control signal S1, the second control signal S2, and the third control signal S3. The above embodiment is a synchronous type switching regulator power stage. In another embodiment, the lower transistor switch Q3 can be replaced by a diode, and this is an asynchronous type switching regulator power stage.

In this invention, the charging from the first common node N21 to the second common node N22 is controlled by the switching regulator power stage 22, so the power conversion efficiency between the first common node N21 and the second common node N22 is better than the prior art.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. An embodiment or a claim of the present invention does not need to achieve all the objectives or advantages of the present invention. The title and abstract are provided for assisting searches but not for limiting the scope of the present invention.

What is claimed is:

1. A charger, for supplying power from an external power source to a first common node and charging a second common node from the first common node, comprising:
a regulator, coupled between the external power source and the first common node, for charging the first common node from the external power source;
a switching regulator power stage, coupled between the first common node and the second common node for charging the second common node from the first common node, the switching regulator power stage being controlled according to a first control signal, a second control signal, and a third signal;
a first amplifier, for generating the first control signal supplied to the switching regulator power stage according to a voltage at the second common node and a first reference signal;
a second amplifier, for generating the second control signal supplied to the switching regulator power stage according to a charging current to the second common node and a second reference signal; and
a third amplifier, for generating the third control signal supplied to the switching regulator power stage according to a voltage at the first common node and a third reference signal.

2. The charger of claim 1, further comprising a fast charge control switch, which is coupled between the first common node and the second common node for fast charging the second common node from the first common node.

3. The charger of claim 2, wherein the fast charge control switch is a transistor which is conducted when the voltage at the second common node is lower than a threshold.

4. The charger of claim 1, further comprising a discharge control unit, which is coupled between the second common node and the first common node for controlling discharge from the second common node to the first common node according to the voltages of the first common node and the second common node.

5. The charger of claim 1, wherein the switching regulator power stage is synchronous or asynchronous type.

6. The charger of claim 1, further comprising a first voltage sensing unit, which is coupled between the first amplifier and the second common node, wherein the first amplifier receives information of the voltage at the second common node through the first voltage sensing unit.

7. The charger of claim 1, further comprising a current sensing unit for sensing the charging current, wherein the second amplifier receives information of the charging current through the current sensing unit.

8. The charger of claim 1, further comprising a second voltage sensing unit, which is coupled between the third amplifier and the first common node, wherein the third amplifier receives information of the voltage at the first common node through the second voltage sensing unit.

9. The charger of claim 8, further comprising a fourth voltage sensing unit, for generating a fourth control signal according to the voltage at the first common node and a fourth reference signal, the fourth control signal controlling the regulator to charge the first common node.

10. The charger of claim 1, further comprising a fourth voltage sensing unit, for generating a fourth control signal according to the voltage at the first common node and a fourth reference signal, the fourth control signal controlling the regulator to charge the first common node.

11. A charge control circuit, for supplying power from an external power source to a first common node and charging a second common node from the first common node, wherein a regulator is coupled between the external power source and the first common node, and a switching regulator power stage is coupled between the first common node and the second common node, the charge control circuit comprising:
a first amplifier, for generating a first control signal supplied to the switching regulator power stage according to a voltage at the second common node and a first reference signal;
a second amplifier, for generating a second control signal supplied to the switching regulator power stage according to a charging current to the second common node and a second reference signal; and
a third amplifier, for generating a third control signal supplied to the switching regulator power stage according to a voltage at the first common node and a third reference signal;
wherein the switching regulator power stage controls the charging from the first common node to the second common node according to the first control signal, the second control signal, and the third signal.

12. The charge control circuit of claim 11, further comprising a fast charge control switch, which is coupled between the first common node and the second common node for fast charging the second common node from the first common node.

13. The charge control circuit of claim 12, wherein the fast charge control switch is a transistor which is conducted when the voltage at the second common node is lower than a threshold.

14. The charge control circuit of claim 11, further comprising a discharge control unit coupled between the second common node and the first common node for controlling discharge from the second common node to the first common node according to voltages at the first common node and the second common node.

15. The charge control circuit of claim 11, further comprising a first voltage sensing unit, which is coupled between the first amplifier and the second common node, wherein the first amplifier receives information of the voltage at the second common node through the first voltage sensing unit.

16. The charge control circuit of claim 11, further comprising a current sensing unit for sensing the charging current, wherein the second amplifier receives information of the charging current through the current sensing unit.

17. The charge control circuit of claim 11, further comprising a second voltage sensing unit, which is coupled between the third amplifier and the first common node, wherein the third amplifier receives information of the voltage at the first common node through the second voltage sensing unit.

18. The charge control circuit of claims 16, further comprising a fourth voltage sensing unit, for generating a fourth control signal according to the voltage at the first common node and a fourth reference signal, the fourth control signal controlling the regulator to charge the first common node.

19. The charge control circuit of claims 10, further comprising a fourth voltage sensing unit, for generating a fourth control signal according to the voltage at the first common node and a fourth reference signal, the fourth control signal controlling the regulator to charge the first common node.
